(19) United States
(12) Patent Application Publication
(10) Pub. No.: US 2006/0250691 A1
(43) Pub. Date: Nov. 9, 2006

(54) Tilting member and tilting actuator having the same

(75) Inventors: Jae Kyung Kim, Kyungki-do (KR); Yang Ho Moon, Kyungki-do (KR); Kyoung Shin Park, Kyungki-do (KR)

Correspondence Address: LOWE HAUPTMAN BERNER, LLP, 1700 DIAGONAL ROAD, SUITE 300, ALEXANDRIA, VA, 22314, US

(73) Assignee: Samsung Electro-Mechanics Co., Ltd., Kyungki-do (JP)

(21) Appl. No.: 11/193,397

(22) Filed: Aug. 1, 2005

(30) Foreign Application Priority Data
May 6, 2005 (KR) 10-2005-38178
Jun. 2, 2005 (KR) 10-2005-47243

(51) Int. Cl. G03B 21/56

(52) U.S. Cl. 359/443; 359/449

(57) ABSTRACT

Disclosed herein are a tilting member and a tilting actuator having the same. The tilting actuator comprises a base having an inner space, a tilting member provided inside the base to perform a slight tilting movement, an image reflector being mounted on an upper surface of the tilting member, and a tilting drive unit to provide external force to a reflector holder of the tilting member, thereby allowing the reflector holder to perform a slight tilting movement about a horizontally disposed torsion unit of the tilting member. With the present invention, it is possible to tilt the image reflector without generation of noise and vibration while ensuring uniform tilting quality with uniform product performance, and to achieve a reduction in manufacturing costs.

### RELATED APPLICATIONS

The present application is based on, and claims priority from, Korean Application Number 2005-38178, filed on May 6, 2005, and Korean Application Number 2005-47243, filed on Jun. 2, 2005, the disclosure of which is incorporated by reference herein in its entirety.

### BACKGROUND OF THE INVENTION

1. Field of the Invention

The present invention relates to a tilting member and a tilting actuator having the same, and, more particularly, to a tilting member and a tilting actuator having the same, which can tilt an image reflector without generation of noise and vibration while ensuring uniform tilting quality with uniform product performance, and can achieve reduced manufacturing costs thereof.

2. Description of the Related Art

In general, a digital light processing (DLP) imaging apparatus achieves an improvement in the reproduction capability of original colors through the removal of a pixel mosaic phenomenon that is a drawback of a general liquid crystal display (LCD) imaging apparatus. The DLP imaging apparatus can produce high-brightness, vivid, large color images suitable for presentations in business, education, and advertisement, or for the entertainment field, such as movies, etc.

Referring to FIG. 12, an example of the DLP imaging apparatus is illustrated in perspective view. As shown in FIG. 12, the DLP imaging apparatus comprises a lamp 10 as a light source, a condenser 20 to gather and irradiate a light beam emitted from the lamp 10, a color wheel 30 to separate white light, gathered in the condenser 20, into red (R), green (G), and blue (B) colors to thereby illuminate one third of the light per each frame thereof, a collimating lens 40 to irradiate the different colors of light, emitted from the color wheel 30, in parallel, a digital mirror device (DMD) 50 to produce an image by adjusting a reflection angle of the different colors of light, gathered in the collimating lens 40, at each pixel, and a projection lens 60 to project the image, produced by the digital mirror device 50, to a screen S as a large scene.

The digital mirror device 50 includes a plurality of two-dimensionally arranged micro digital mirrors (not shown), each having a fine size to charge a single pixel on a silicon wafer. The micro digital mirrors are designed to convert a path of incident light between two states, i.e. On and Off states, as they perform tilting movements at a very high speed, respectively, depending on digital information that is provided to the digital mirror device 50 by hardware and software controllers.

An original small image, consisting of pixels that are respectively controlled in the digital mirror device 50, is enlarged via the projection lens 60, thereby being formed on the screen S as a large scene.

However, the DLP imaging apparatus, designed to enlarge an original small image to thereby project it as a large scene, has the problem in that the large scene is deteriorated in image quality as compared to the original small image. Also, in the case of rapid-scene change or when a visual field of a viewer moves fast, for example, when an iridescent color is seen in a high contrast ratio area, such as a black linear design on a white background, or lattice patterns between respective pixels are noticeable by fast movement of the visual field, image quality of the large scene formed on the screen is deteriorated.

Therefore, to increase the resolution of the scene formed on the screen, when light, reflected by the digital mirror device to the projection lens to thereby be enlarged via the projection lens, is directed to the screen, an incidence angle of the light must be delicately adjusted to cause an optical illusion phenomenon. For this, it has been conventionally proposed to interpose a tilting actuator between the digital mirror device 50 and the projection lens 60 to slightly tilt an image reflector that periodically reflects the light by a short interval of 0.0167 sec.

However, the conventional tilting actuator has the problem in that a tilting structure thereof to repeatedly tilt the image reflector is bulky and heavy. This requires excess driving force during a tilting operation, and results in a deterioration of operational accuracy due to generation of noise and vibration. Also, the conventional tilting actuator suffers from complicated assembly structure thereof and hence increased manufacturing costs, and cannot achieve uniform tilting quality between products due to product performance variation.

### SUMMARY OF THE INVENTION

Therefore, the present invention has been made in view of the above problems, and it is an object of the present invention to provide a tilting member and a tilting actuator having the same, which can tilt an image reflector without generation of noise and vibration while ensuring uniform tilting quality with uniform product performance, and can achieve reduced manufacturing costs thereof.

In accordance with a first aspect of the present invention, the above and other objects can be accomplished by the provision of a tilting member comprising: a holder supporting unit formed with at least one opening having a predetermined size; a torsion unit connected at opposite lateral ends thereof to opposite inner sides of the opening; and a reflector holder connected to the holder supporting unit via the torsion unit and adapted to perform a slight tilting movement about the torsion unit.

Preferably, the torsion unit may include: a fixed center body integrally provided at a lower surface of the reflector holder; and a pair of lateral wings horizontally extending from opposite lateral ends of the fixed center body to be integrally connected to the opposite inner sides of the opening.

Preferably, the fixed center body may have a width lager than a width of the lateral wings.

Preferably, the lateral wings may have a thickness different from a plate thickness of the holder supporting unit.

Preferably, the fixed center body may have a thickness larger than a plate thickness of the holder supporting unit to define a gap having a predetermined size between the holder supporting unit and the reflector holder.

Preferably, the holder supporting unit and the reflector holder may be arranged at different planes from each other by interposing the torsion unit.

Preferably, the gap between the holder supporting unit and the reflector holder is controlled depending on a thickness of the fixed center body of the torsion unit.

Preferably, a pair of torsion units may horizontally extend from opposite lateral surfaces of the reflector holder to be connected to the opening of the holder supporting unit.

Preferably, the holder supporting unit, the torsion units, and the reflector holder may be arranged at the same plane as one another.

Preferably, a gap between the holder supporting unit and the reflector holder may be controlled depending on a length of the torsion units.

Preferably, an image reflector may be mounted on an upper surface of the reflector holder.

In accordance with a second aspect of the present invention, the above and other objects can be accomplished by the provision of a tilting member comprising: a holder supporting unit: torsion units connected to an upper or lower surface of the holder supporting unit; and a reflector holder integrally provided at opposite lateral sides thereof with the torsion units, respectively, and adapted to perform a slight titling movement about the torsion units.

Preferably, each of the torsion units may include: an external fixed body affixed to the holder supporting unit; and an external neck portion to integrally connect the external fixed body to one of the opposite lateral sides of the reflector holder.

Preferably, the external fixed body may have a fixing hole for use in the insertion of one of fixing pins formed at the holder supporting unit.

Preferably, a pair of upper fastening holes may be formed at opposite lateral sides of the fixing hole to correspond to lower fastening holes of the holder supporting unit.

Preferably, the fixing hole may be positioned to have approximately the same horizontal axis as the external neck portion.

Preferably, each of the torsion units may include: an internal fixed body received in a torsion unit exposure opening perforated through the reflector holder to be affixed to the holder supporting unit; and an internal neck portion to integrally connect the internal fixed body to the reflector holder.

Preferably, the internal fixed body may have a fixing hole for use in the insertion of one of fixing pins formed at the holder supporting unit.

Preferably, a pair of upper fastening holes may be formed at opposite lateral sides of the fixing hole to correspond to lower fastening holes of the holder supporting unit.

Preferably, the fixing hole may be positioned to have approximately the same horizontal axis as the internal neck portion.

Preferably, the torsion unit exposure opening may have approximately the same shape as the internal fixed body.

Preferably, the holder supporting unit may have one or more openings having a predetermined size and formed at locations corresponding to the reflector holder.

Preferably, an image reflector may be mounted on an upper surface of the reflector holder.

In accordance with a third aspect of the present invention, the above and other objects can be accomplished by the provision of a tilting actuator comprising: a base having an inner space; a tilting member provided inside the base to perform a slight tilting movement, an image reflector being mounted on an upper surface of the tilting member; and a tilting drive unit to provide external force to a reflector holder of the tilting member, thereby slightly tilting the reflector holder about a horizontally disposed torsion unit of the tilting member.

Preferably, the tilting member may include: a holder supporting unit formed with at least one opening having a predetermined size; the torsion unit connected at opposite lateral ends thereof to opposite inner sides of the opening; and the reflector holder connected to the holder supporting unit via the torsion unit and adapted to perform a slight tilting movement about the torsion unit.

Preferably, the torsion unit may include: a fixed center body integrally provided at a lower surface of the reflector holder; and a pair of lateral wings horizontally extending from opposite lateral ends of the fixed center body to be integrally connected to the opposite inner sides of the opening.

Preferably, the fixed center body may have a width lager than a width of the lateral wings.

Preferably, the lateral wings may have a thickness different from a plate thickness of the holder supporting unit.

Preferably, the fixed center body may have a thickness larger than a plate thickness of the holder supporting unit to define a gap having a predetermined size between the holder supporting unit and the reflector holder.

Preferably, the holder supporting unit and the reflector holder may be arranged at different planes from each other by interposing the torsion unit.

Preferably, the gap between the holder supporting unit and the reflector holder may be controlled depending on a thickness of the fixed center body of the torsion unit.

Preferably, a pair of torsion units may horizontally extend from opposite lateral surfaces of the reflector holder to be connected to the opening of the holder supporting unit.

Preferably, the holder supporting unit, the torsion units, and the reflector holder may be arranged at the same plane as one another.

Preferably, a gap between the holder supporting unit and the reflector holder may be controlled depending on a length of the torsion units.

Preferably, the tilting member may include: a holder supporting unit: torsion units connected to an upper or lower surface of the holder supporting unit; and a reflector holder integrally provided at opposite lateral sides thereof with the torsion units, respectively, and adapted to perform a slight titling movement about the torsion units.

Preferably, each of the torsion units may include: an external fixed body to be affixed to the holder supporting unit; and an external neck portion to integrally connect the external fixed body to one of the opposite lateral sides of the reflector holder.

Preferably, the external fixed body may have a fixing hole for use in the insertion of one of fixing pins formed at the holder supporting unit.

Preferably, a pair of upper fastening holes may be formed at opposite lateral sides of the fixing hole to correspond to lower fastening holes of the holder supporting unit.

Preferably, the fixing hole may be positioned to have approximately the same horizontal axis as the external neck portion.

Preferably, each of the torsion units may include: an internal fixed body received in a torsion unit exposure opening perforated through the reflector holder to be affixed to the holder supporting unit; and an internal neck portion to integrally connect the internal fixed body to the reflector holder.

Preferably, the internal fixed body may have a fixing hole for use in the insertion of one of fixing pins formed at the holder supporting unit.

Preferably, a pair of upper fastening holes may be formed at opposite lateral sides of the fixing hole to correspond to lower fastening holes of the holder supporting unit.

Preferably, the fixing hole may be positioned to have approximately the same horizontal axis as the internal neck portion.

Preferably, the torsion unit exposure opening may have approximately the same shape as the internal fixed body.

Preferably, the holder supporting unit may have one or more openings having a predetermined size and formed at locations corresponding to the reflector holder.

Preferably, a protrusion may be formed at a lower surface of the reflector holder to correspond to each opening of the holder supporting unit, and a coil may be wound around the protrusion.

Preferably, the tilting member may be a molded article made of a metal material having an elastic restoration force.

Preferably, the tilting member may be a molded article made of a resin material having an elastic restoration force.

Preferably, the tilting drive unit may include: one or more magnetic portions fixedly mounted at a bottom surface of the base; and one or more coil portions fixedly mounted to the reflector holder.

Preferably, each magnetic portion may include: a yoke having an opened upper end and a closed lower end to define an inner space, the lower end being fixedly located in a seating recess formed at the bottom surface of the base; and a magnet received in the inner space of the yoke and adapted to produce a magnetic field of predetermined strength.

Preferably, an upper yoke may be inserted to the top of the yoke to be seated on an upper surface of the magnet.

Preferably, each coil portion may include: a coil shaft having a predetermined length, the coil shaft being affixed at an upper end thereof to the reflector holder to thereby be inserted into a corresponding one of the magnetic portions; and a coil wound around the coil shaft to have a predetermined number of turns, the coil being electrically connected to an external power source.

### BRIEF DESCRIPTION OF THE DRAWINGS

The above and other objects, features and other advantages of the present invention will be more clearly understood from the following detailed description taken in conjunction with the accompanying drawings, in which:

FIGS. 1a and 1b are a bottom perspective view and a top perspective view illustrating a tilting member according to a first embodiment of the present invention;

FIG. 2 is a perspective view illustrating a longitudinal section of the tilting member according to the first embodiment of the present invention;

FIG. 3 is a perspective view illustrating a tilting member according to a second embodiment of the present invention;

FIGS. 4a and 4b are a top perspective view and a bottom perspective view illustrating a holder supporting unit and a reflector holder of a tilting member according to a third embodiment of the present invention;

FIGS. 5a and 5b are a top perspective view and a bottom perspective view illustrating the tilting member according to the third embodiment of the present invention;

FIG. 6a is a perspective view illustrating a holder supporting unit of a tilting member according to a fourth embodiment of the present invention;

FIG. 6b is a perspective view illustrating a reflector holder of the tilting member according to the fourth embodiment of the present invention;

FIGS. 7a and 7b are a top perspective view and a bottom perspective view illustrating the tilting member according to the fourth embodiment of the present invention;

FIG. 8 is a perspective view illustrating a tilting actuator according to the present invention;

FIG. 9 is a perspective view of the tilting actuator according to the present invention, only a base of the tilting actuator being shown in a longitudinally cut-away state;

FIG. 10 is a perspective view of the tilting actuator according to the present invention, only the base and tilting member being shown in a longitudinally cut-away state;

FIGS. 11a to 11c are schematic views illustrating screen images tilted by the tilting actuator according to the present invention; and

FIG. 12 is a perspective view illustrating a large-scale imaging apparatus employing a digital reflection mirror.

### DESCRIPTION OF THE PREFERRED EMBODIMENTS

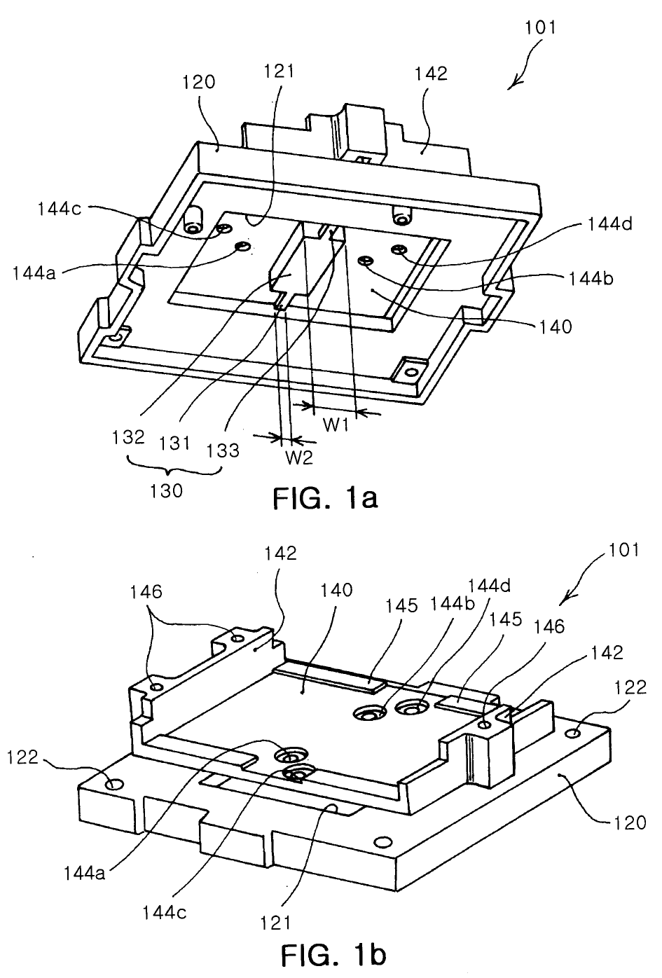

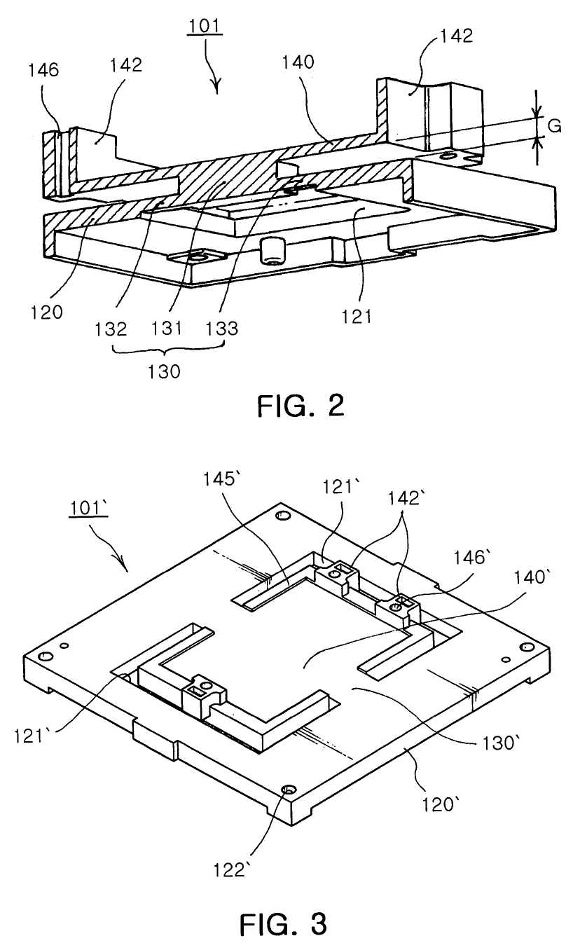

FIGS. 1a and 1b are a bottom perspective view and a top perspective view illustrating a tilting member according to a first embodiment of the present invention. FIG. 2 is a perspective view illustrating a longitudinal section of the tilting member according to the first embodiment of the present invention.

As shown in FIGS. 1a, 1b and 2, the tilting member 101 of the present invention includes a holder supporting unit 120, a torsion unit 130, and a reflector holder 140, which are integrally formed with each other to repeatedly perform a horizontal reciprocation tilting movement when external force is applied thereto.

The holder supporting unit 120 is a supporting structure having a rectangular plate shape, and is configured to be assembled to a base 110 that will be explained hereinafter. The holder supporting unit 120 is perforated at a central region thereof with an opening 121 having a predetermined size.

The opening 121 has the same rectangular shape as the rectangular plate-shaped holder supporting unit 120. To opposite longer sides of the opening 121 are integrally affixed the torsion unit 130 to be exposed to the outside at a lower surface thereof via the opening 121.

A plurality of fastening holes 122 are formed at corners of the holder supporting unit 120 so that the holder supporting unit 120 is assembled to the base 110 by means of a plurality of fastening members.

The torsion unit 130 is a connection member to integrally connect the holder supporting unit 120 to the reflector holder 140. If external force is applied to the torsion unit 130 from a lower side thereof, the torsion unit 130 is distorted about a horizontal axis thereof to thereby supply an elastic restoration force.

The torsion unit 130 includes a fixed center body 132 integrally provided at a lower surface of the reflector holder 140, and a pair of lateral wings 131 and 133 horizontally extending from opposite lateral ends of the fixed center body 132 by a predetermined length to be integrally connected to the opposite longer sides of the opening 121.

Here, although the fixed center body 132 and the lateral wings 131 and 133 have the same width as each other, it is preferable that the lateral wings 131 and 133 have a smaller width W2 than a width W1 of the fixed center body 132 to achieve an increased elastic restoration force upon torsional deformation of the torsion unit 130.

The fixed center body 132 is a rectangular parallelepiped structure positioned directly at the center of the opening 121. The lateral wings 131 and 133 are extension bars having a rectangular cross section. As stated above, the lateral wings 131 and 133 horizontally extend from the opposite lateral ends of the fixed center body 132 by the predetermined length, thereby being integrally connected to the longer sides of the opening 121.

Preferably, both the lateral wings 131 and 133, extending from the opposite lateral ends of the fixed center body 132, have the same length as each other, and have a smaller thickness than a thickness of a plate portion of the holder supporting unit 120 to facilitate torsional deformation thereof, but the present invention is not limited to this configuration. Admittedly, the lateral wings 131 and 133 may have a thickness equal to or larger than the plate thickness of the holder supporting unit 120.

A thickness of the fixed center body 132 has to be larger than the plate thickness of the holder supporting unit 120 around the opening 121 to define a predetermined gap G between the holder supporting unit 120 and the reflector holder 140. The gap G between the holder supporting unit 120 and the reflector holder 140 is able to be appropriately controlled by varying the thickness of the fixed center body 132.

That is, by interposing the torsion unit 130, the holder supporting unit 120 and the reflector holder 140 are arranged at different planes from each other to have a height difference.

The reflector holder 140 is a rectangular plate-shaped structure that is integrally provided at the lower surface thereof with the torsion unit 130. At an upper surface of the reflector holder 140 is horizontally mounted an image reflector M.

The lower surface of the reflector holder 140 is integrally connected to an upper surface of the fixed center body 132 of the torsion unit 130, and a pair of upright blocks 142 is formed at opposite lateral ends of the reflector holder 140 thereof to have a predetermined height. Each upright block 142 has an appropriate number of fastening holes 146 formed at an upper surface thereof.

A pair of connection holes 144a and 144b is perforated through the reflector holder 140 for the connection of a tilting drive unit 150 that will be explained hereinafter. The connection holes 144a and 144b have a symmetrical structure about the torsion unit 130. Also, auxiliary connection holes 144c and 144d are perforated near the connection holes 144a and 144b, respectively.

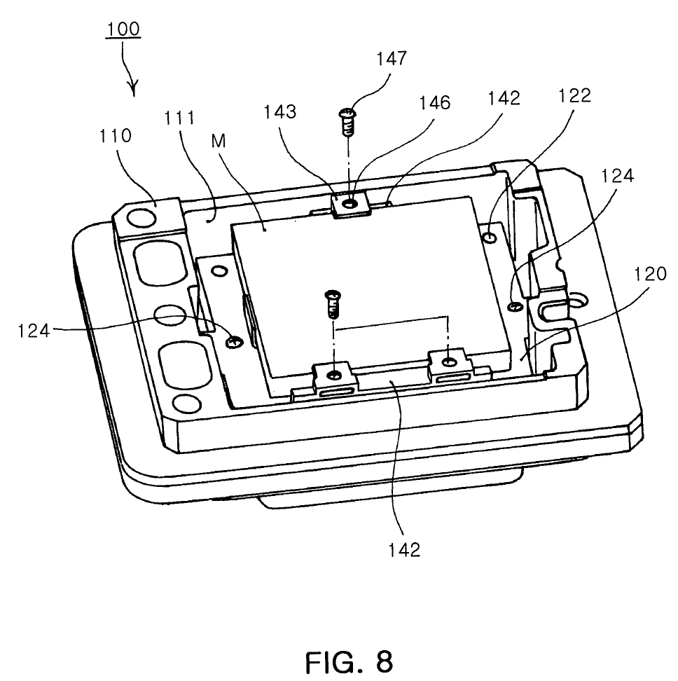

Preferably, the reflector holder 140 further includes a plurality of raised portions 145 protruding upward from outer circumferential locations of the upper surface of the reflector unit 140 by a predetermined height. The raised portions 145 are adapted to come into contact at their upper surfaces with a lower surface of the image reflector M at outer circumferential locations thereof when the image reflector M is located at a fixed position on the reflector holder 140 by means of fixing members 143 (See FIG. 8). With this configuration, the raised portions 145 are able to prevent the lower surface of the image reflector M from coming into full contact with the upper surface of the reflector holder 140.

As shown in FIG. 8, after the image reflector M is placed on the upper surface of the reflector holder 140, the fixing members 143 are assembled to upper ends of the upright blocks 142 as fastening members 147 are coupled through the fastening holes 146. Thereby, the image reflector M is firmly located on the reflector holder 140 at a fixed position without the risk of horizontal and vertical displacement thereof.

FIG. 3 is a perspective view illustrating a tilting member according to a second embodiment of the present invention. Considering the tilting member 101′ of the present embodiment, a holder supporting unit 120′ is formed at certain positions thereof with a pair of openings 121′. A pair of torsion units 130′ horizontally extends from opposite lateral surfaces of a reflector holder 140′ to have the same thickness as that of the reflector holder 140′. The torsion units 130′ are integrally connected to the holder supporting unit 120′ between both the openings 121′.

Each of the openings 121′ is perforated through the holder supporting unit 120′ from an upper surface to a lower surface thereof to have a U-shaped cross section, and provides a room for tilting movement of the reflector holder 140′. The openings 121′ have a symmetrical structure about a torsional axis of the torsion units 130′.

In the present embodiment, a gap between the holder supporting unit 120′ and the reflector holder 140′ is determined depending on a length of the torsion units 130′. All the holder supporting unit 120′, the torsion units 130′ and the reflector holder 140′ are arranged at the same plane as one another.

Similar to the first embodiment, at an upper surface of the reflector holder 140′ are formed upright blocks 142′, and the upright blocks 142 have fastening holes 146′ to locate the image reflector M on the reflector holder 140′ at a fixed position. Also, raised portions 145′ are formed at the upper surface of the reflector holder 140′ so that the image reflector M is placed thereon.

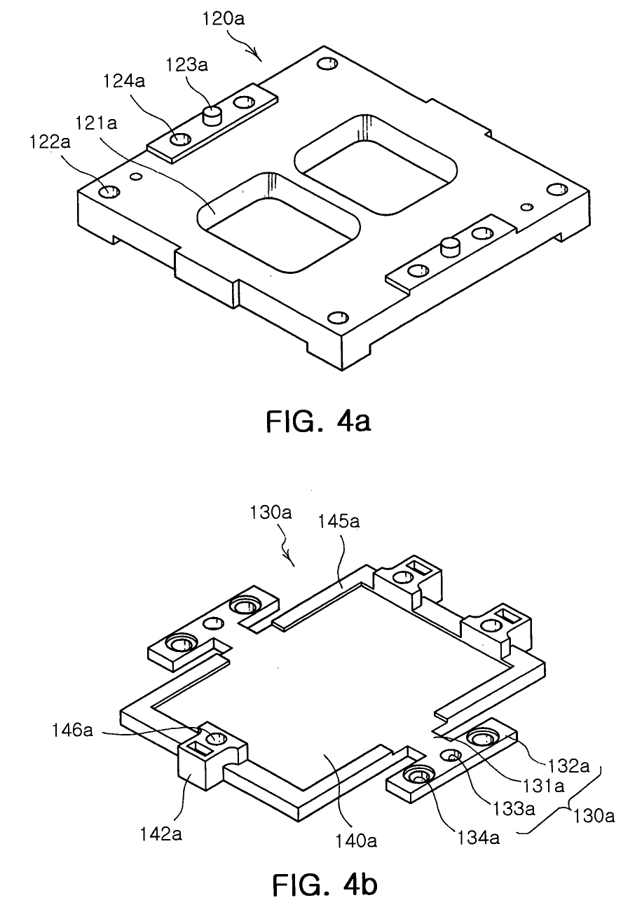

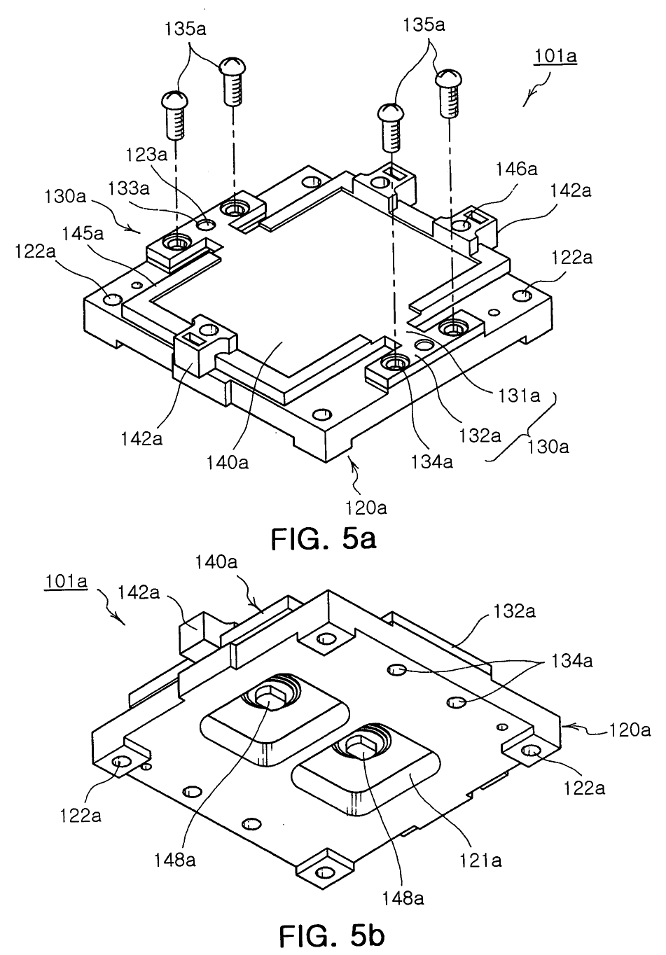

FIGS. 4a and 4b are a top perspective view and a bottom perspective view illustrating a holder supporting unit and a reflector holder of a tilting member according to a third embodiment of the present invention. FIGS. 5a and 5b are a top perspective view and a bottom perspective view illustrating the tilting member according to the third embodiment of the present invention.

As shown in FIGS. 4a, 4b, 5a and 5b, the tilting member 101a of the present embodiment comprises a holder supporting unit 120a, a pair of torsion units 130a, and a reflector holder 140a.

The holder supporting unit 120a is a supporting structure having a rectangular plate shape and is configured to be assembled to the base 110. One or more openings 121a, each having a predetermined size, are perforated through a central region of the holder supporting unit 120a to expose a lower surface of the reflector holder 140a, located on the holder supporting unit 120a, to the outside.

A plurality of fastening holes 122a are formed at corners of the holder supporting unit 120a so that the holder supporting unit 120a is assembled to the base 110 by means of a plurality of fastening members.

The torsion units 130a are connection members integrally provided at opposite lateral sides of the reflector holder 140a to be assembled to an upper surface of the holder supporting unit 120a. If external force is applied to the torsion units 130a from a lower side of the reflector holder 140a, the torsion units 130 undergo torsional deformation to thereby supply an elastic restoration force.

Each of the torsion units 130a includes an external fixed body 132a having a fixing hole 133a perforated therethrough, and an external neck portion 131a to integrally connect the external fixed body 132a to one of the opposite lateral sides of the reflector holder 140a. The fixing hole 133a is used for the insertion of one of fixing pins 123a that protrude from the upper surface of the holder supporting unit 120a at opposite lateral locations thereof by a predetermined height.

The torsion unit 130a further includes a pair of upper fastening holes 134a formed at opposite lateral sides of the fixing hole 133a to correspond to lower fastening holes 124a of the holder supporting unit 120a. As fastening members 135a are coupled through the upper and lower fastening holes 134a and 124a, the holder supporting unit 120a is integrally connected with the reflector holder 140a.

Alternatively, pin members may substitute for the lower fastening holes 124a of the holder supporting unit 120a, thereby being inserted into the upper fastening holes 134a in the same manner as the fixing pin 123a. Also, a lower surface of the external fixed body 132a may be integrally bonded to the upper surface of the holder supporting unit 120a by means of an adhesive.

The external fixed bodies 132a of both the torsion units 130a are rectangular parallelepiped structures provided at the opposite lateral sides of the reflector holder 140a. The external neck portions 131a of the torsion units 130a are extension bars having a rectangular cross section, and horizontally extend from a side of the respective external fixed bodies 132a by a predetermined length to be integrally connected to the opposite lateral sides of the reflector holder 140a.

Preferably, both the external neck portions 131a, extending between the opposite lateral sides of the reflector holder 140a and the external fixed bodies 132a, are positioned to have approximately the same horizontal axis as the fixing holes 133a.

The external neck portions 131a may have the same thickness as that of the external fixed bodies 132a and the reflector holder 140a, or may have a different thickness from them.

The reflector holder 140a is a rectangular plate-shaped structure that is integrally provided at the opposite lateral sides thereof with the torsion units 130a. At an upper surface of the reflector holder 140a is horizontally mounted an image reflector M.

The reflector holder 140a includes a plurality of upright blocks 142a having a predetermined height. Each upright block 142a has a fastening hole 146a formed at an upper surface thereof.

The reflector holder 140a further includes connection holes formed at a lower surface thereof for the connection of coil shafts 155 of the tilting drive unit 150 that will be described hereinafter. Alternatively, to substitute for the coil shafts 155, one or more protrusions 148a may be integrally formed at the lower surface of the reflector holder 140a to extend downward by a predetermined length. In this case, coils 156 are wound on the respective protrusions 148a.

Here, the protrusions 148a are exposed downward through the openings 121a of the holder supporting unit 120a to be connected to the tilting drive unit 150.

Preferably, the reflector holder 140a further includes a plurality of raised portions 145a protruding upward from outer circumferential locations of the upper surface of the reflector unit 140a by a predetermined height. The raised portions 145a are adapted to come into contact at their upper surfaces with the lower surface of the image reflector M at outer circumferential locations thereof, thereby preventing the lower surface of the image reflector M from coming into full contact with the upper surface of the reflector holder 140a.

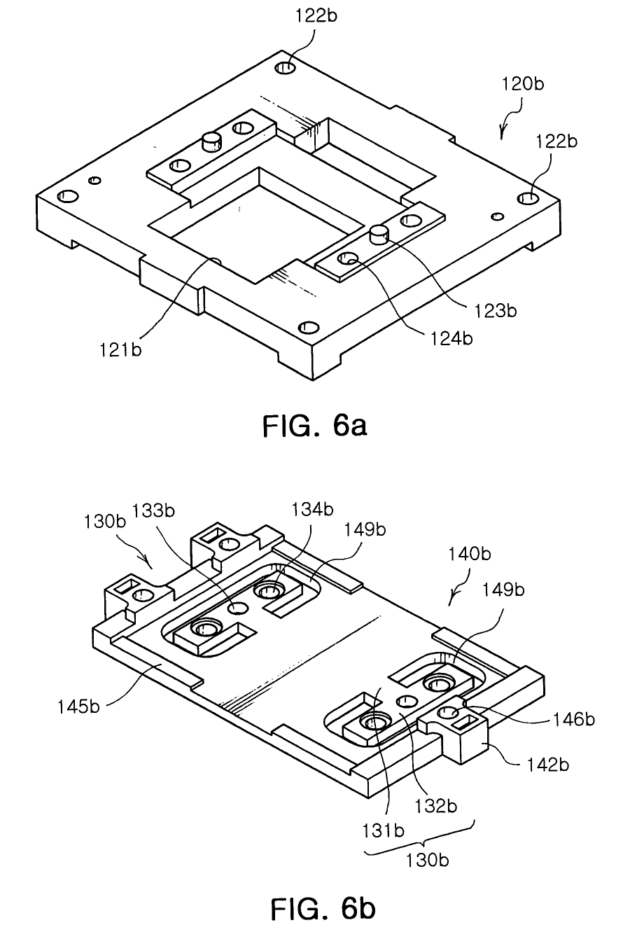

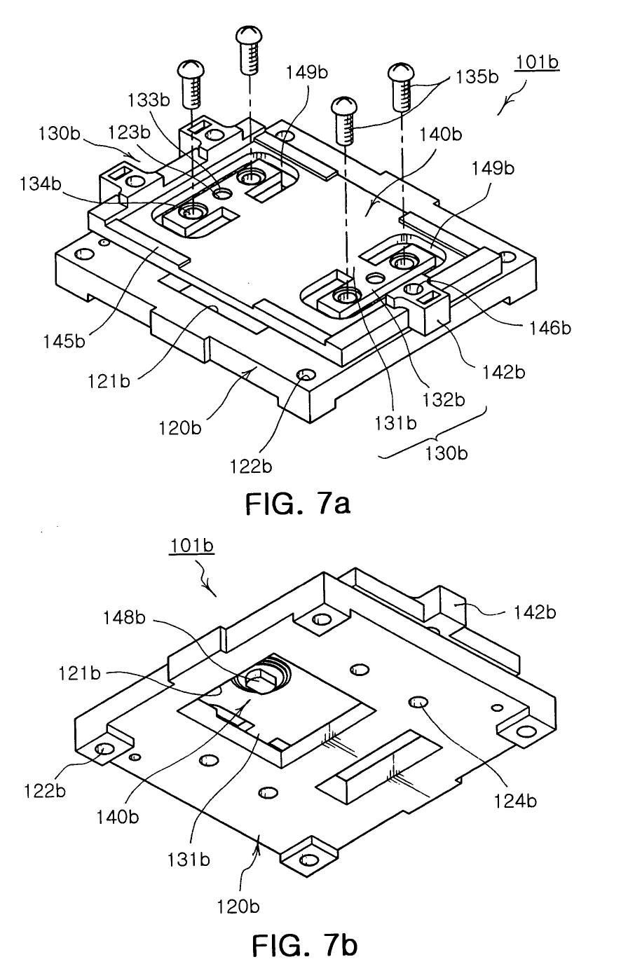

FIG. 6a is a perspective view illustrating a holder supporting unit of a tilting member according to a fourth embodiment of the present invention. FIG. 6b is a perspective view illustrating a reflector holder of the tilting member according to the fourth embodiment of the present invention. FIGS. 7a and 7b are a top perspective view and a bottom perspective view illustrating the tilting member according to the fourth embodiment of the present invention.

As shown in FIGS. 6a, 6b, 7a and 7b, the tilting member 101b of the present embodiment comprises a holder supporting unit 120b, a pair of torsion units 130b, and a reflector holder 140b.

The holder supporting unit 120b is a supporting structure having a rectangular plate shape, and is configured to be assembled to the base 110. One or more openings 121b having predetermined sizes are perforated through the holder supporting unit 120b to expose the reflector holder 140b to the outside therethrough.

A plurality of fastening holes 122b are formed at corners of the holder supporting unit 120b so that the holder supporting unit 120b is assembled to the base 110 by means of a plurality of fastening members.

The torsion units 130b are connection members integrally formed at opposite lateral locations of the reflector holder 140b to be assembled to an upper surface of the holder supporting unit 120b. If external force is applied to the torsion units 130b from a lower side of the reflector holder 140b, the torsion units 130 undergo torsional deformation to thereby supply an elastic restoration force.

Each of the torsion units 130b includes an internal fixed body 132b received in a torsion unit exposure opening 149b perforated through the reflector holder 140b, and an internal neck portion 131b to integrally connect the internal fixed body 132b to the reflector holder 140b. The internal fixed body 132b is perforated with a fixing hole 133b therethrough to allow one of fixing pins 123b, that protrude from the upper surface of the holder supporting unit 120b at opposite lateral locations by a predetermined height, to be inserted therethrough.

The torsion unit 130a further includes a pair of upper fastening holes 134b formed at opposite lateral sides of the fixing hole 133b to correspond to lower fastening holes 124b of the holder supporting unit 120b. As fastening members are fastened through the upper and lower fastening holes 134b and 124b, the holder supporting unit 120b is integrally connected with the reflector holder 140b.

Alternatively, pin members may substitute for the lower fastening holes 124b of the holder supporting unit 120b to be inserted into the upper fastening holes 134b, in the same manner as the fixing pin 123b. Also, a lower surface of the internal fixed body 132b may be integrally bonded to the upper surface of the holder supporting unit 120b by means of an adhesive.

The internal fixed bodies 132b of both the torsion units 130b are rectangular parallelepiped structures received in the torsion unit exposure openings 149b of the reflector holder 140b, respectively. The internal neck portions 131b of the torsion units 130b are extension bars having a rectangular cross section, and horizontally extend from a side of the respective torsion unit exposure openings 149b to be integrally connected to the internal fixed bodies 132b.

Preferably, the internal neck portions 131b are positioned to have approximately the same horizontal axis as the fixing holes 133b.

The internal neck portions 131b may have the same thickness as that of the internal fixed bodies 132b and the reflector holder 140b, or may have a different thickness from them.

The reflector holder 140b is a rectangular plate-shaped structure that is integrally provided therein with the torsion units 130b. At an upper surface of the reflector holder 140b is horizontally mounted the image reflector M.

The reflector holder 140b includes a plurality of upright blocks 142b protruding from the upper surface thereof to have a predetermined height. Each block 143b has a fastening hole 146b formed at an upper surface thereof.

The reflector holder 140b further includes a connection hole formed at a lower surface thereof for the connection of the coil shaft 155 of the tilting drive unit 150. Alternatively, to substitute for the coil shaft 155, at least one protrusion 148b may be integrally formed at the lower surface of the reflector holder 140b to extend downward by a predetermined length. In this case, the coil 156 is wound on the protrusion 148b.

Here, the protrusion 148b is exposed downward through the opening 121b of the holder supporting unit 120b to be connected to the tilting drive unit 150.

Preferably, the reflector holder 140b further includes a plurality of raised portions 145b protruding upward from outer circumferential locations of the upper surface of the reflector unit 140b by a predetermined height. The raised portions 145b are adapted to come into contact at their upper surfaces with the lower surface of the image reflector M at outer circumferential locations thereof, thereby preventing the lower surface of the image reflector M from coming into full contact with the upper surface of the reflector holder 140b.

In both the third and fourth embodiments of the present invention, at the upper surfaces of both the holder supporting units 120a and 120b, which correspond to the lower surfaces of the external and internal fixed bodies 132a and 132b, may be formed projections having a predetermined height to define a gap between the holder supporting units 120a and 120b and the reflector holders 140a and 140b. Alternatively, it is preferable that the external and internal fixed bodies 132a and 132b, assembled to the upper surfaces of the holder supporting units 120a and 120b, have a larger thickness than that of the reflector holders 140a and 140b.

The above described tilting members 101, 101′, 101a, and 101b may be manufactured by processing a metal material or may be manufactured by molding a metal material having an elastic restoration force or resin material.

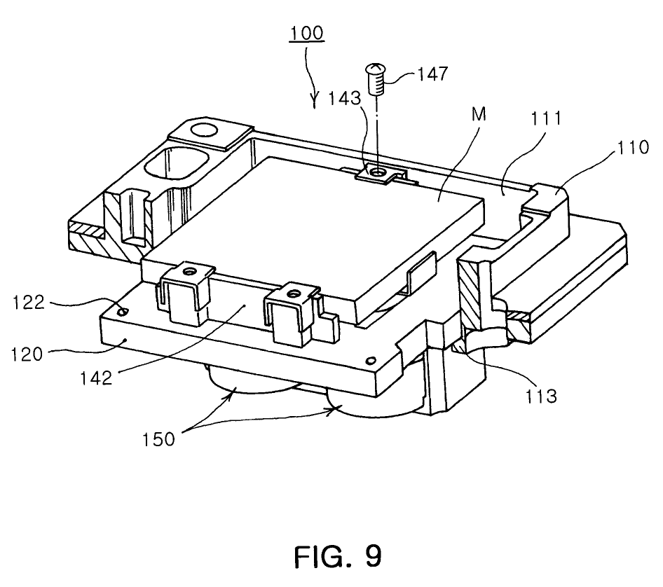

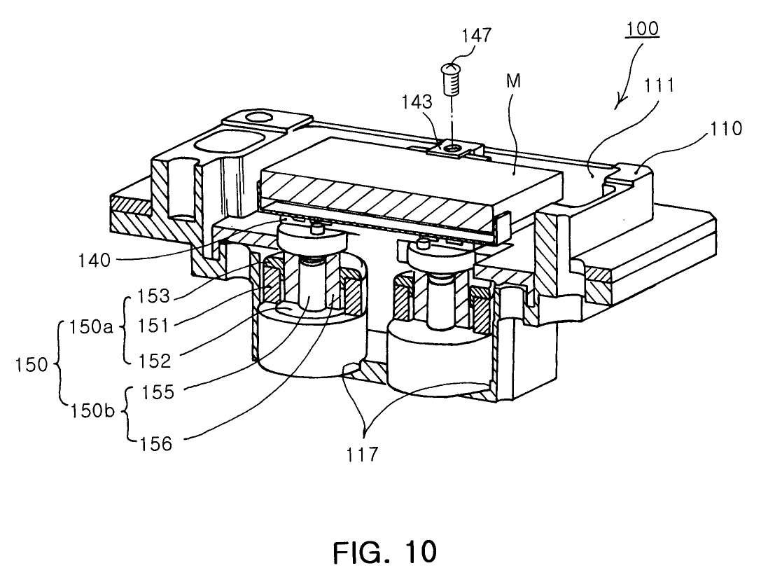

FIG. 8 is a perspective view illustrating a tilting actuator according to the present invention. FIG. 9 is a perspective view of the tilting actuator according to the present invention, only a base of the tilting actuator being shown in a longitudinally cut-away state. FIG. 10 is a perspective view of the tilting actuator according to the present invention, only the base and tilting member being shown in a longitudinally cut-away state.

The tilting actuator 100 of the present invention comprises one of the tilting members 101, 101′, 101a and 101b each including the holder supporting unit 120, 120′, 120a, or 120b, the torsion unit 130, 130′, 130a, or 130b, and the reflector holder 140, 140′, 140a, or 140b, the base 110, and the tilting drive unit 150. Although the tilting actuator 100 may vary in configuration through the use of the different tilting members 101, 101′, 101a, and 101b according to the first to fourth embodiments, it exhibits the same operational effects throughout the first to fourth embodiments. Thus, the following description in relation with FIGS. 8 to .10 will be explained based on the tilting member 101 of the first embodiment wherein the torsion unit 130 is integrally formed between the holder supporting unit 120 and the reflector holder 140.

The base 110 is a fixed structure having a rectangular frame shape. An opening 111 having a predetermined size is formed in an upper portion of the base 110, and a bottom surface of the base 110 is closed to define an inner space having a predetermined volume. Along an inner circumference of the base 110 is formed an inwardly protruded rim 113. The inwardly protruded rim 113 has a plurality of fastening holes that correspond to a plurality of fastening holes 122 formed at the corners of the holder supporting unit 120.

Here, the inwardly protruded rim 113 has lower screw holes centrally formed at respective sides thereof, and the holder supporting unit 120 has upper screw holes 124 formed at outer circumferential locations corresponding to the lower screw holes of the inwardly protruded rim 113. Adjustment screws are fastened through the upper and lower screw holes to adjust a horizontal state of the tilting member 101, thereby coinciding a horizontal degree of the image reflector M to a standard horizontal degree of an upper surface of the base 110. Preferably, the adjustment screws have springs configured to come into contact at their upper and lower ends with the holder supporting unit 120 and the inwardly protruded rim 113 of the base 110 to provide a predetermined elastic force.

The tilting drive unit 150 provided between the reflector holder 140 and the bottom surface of the base 110 provides external force required to slightly tilt the reflector holder 140 in opposite directions about the torsion unit 130.

The tilting drive unit 150 includes a pair of magnetic portions 150a to provide a magnetic field, and a pair of coil portions 150b to provide an electric field. With the interaction between the magnetic field and the electric field obtained by both the magnetic portions 150a and the coil portions 150b, the coil portions 150b, affixed to the lower surface of the reflector holder 140, are alternately operated in a vertical direction, thereby inducing a tilting operation of the reflector holder 140, i.e. the image reflector M, about the torsion unit 130.

As shown in FIG. 10, a pair of the magnetic portions 150a, arranged underneath the reflector holder 140, may have a symmetrical structure about the torsion unit 130, but the present invention is not limited to this configuration. Alternatively, only one magnetic portion 150a may be provided on a side of the torsion unit 130.

Each magnetic portion 150a includes a yoke 151, and a magnet 152. The yoke 151 is a cylindrical member having an opened upper end and a closed lower end to define an inner space having a predetermined volume. The lower end of the yoke 151 is fixedly located in a seating recess 117 formed at the bottom surface of the base 110.

The magnet 152 is a hollow cylindrical magnet received in the inner space of the yoke 151. A north pole and a south pole of the magnet 152 are vertically arranged to each other to produce a magnetic field of predetermined strength.

Preferably, a bottom surface of the yoke 151 is partially protruded upward by a predetermined height to form an annular protruded portion, and the magnet 152 is seated at an upper surface of the annular protruded portion. This configuration is effective to ensure more smooth flow of a magnetic flux toward the yoke 51.

More preferably, the magnetic portion 150a further includes a hollow cylindrical upper yoke 153, which is inserted to the top of the yoke 51 to be seated on an upper surface of the magnet 152. The hollow cylindrical upper yoke 153 serves to ensure more smooth flow of the magnetic flux between the magnet 152 and the yoke 151.

As shown in FIG. 10, each coil portion 150b, that is inserted into one of the magnetic portions 150a, includes the coil shaft 155 and the coil 156. The coil shaft 155 is a shaft member having a predetermined length. An upper end of the coil shaft 155 is assembled and fixed in the connection hole 144a or 144b perforated through the reflector holder 140. The coil 156 is wound around the coil shaft 155 to have a predetermined number of turns, thereby serving to produce an electric field when power from a power source (not shown) is applied thereto.

Meanwhile, according to the third or fourth embodiment of the present invention, the coil shaft 155 may be substituted by the protrusion 148a or 148b, which is protruded from the lower surface of the reflector holder 140a or 140b. In this case, the protrusion 148a or 148b is received in the magnetic portion 150a, and the coil 156 is wound around the protrusion 148a or 148b by the predetermined number of turns.

In the present invention, the power source is a substrate member mounted at the bottom surface of the base 110 to be electrically connected with the coils 156 of the coil portions 150b to supply electric power thereto.

When a pair of the coil portions 150b are provided at the reflector holder 140, a controller (not shown) of the power source is operated to alternately reciprocate the coil portions 150b in a vertical direction and to periodically alternate the polarity of electric current applied to the coils 156.

With this configuration, when positive current is applied to one of the coil portions 150b disposed underneath the reflector holder 140 to induce the rising operation of the coil portion 150b, negative current is applied to the other coil portion 150b to induce the lowering operation of the other coil portion 150b. Thereby, the reflector holder 140, which is connected to the holder supporting unit 120 by means of the torsion unit 130, is able to be tilted in opposite directions about the torsion unit 130 and hence, the image reflector M, assembled to the reflector holder 140, is repeatedly tilted by the same tilting angle as that of the reflector holder 140.

To achieve the tilting operation of the image reflector M under operation of the tilting actuator 100 configured as stated above, according to the present invention, electric currents having different polarities are applied to the pair of coil portions 150b which are electrically connected to the power source and are arranged next to each other between the reflector holder 140 and the base 110.

Thereby, the electric currents having different polarities are applied to the coils 156 which are wound in a direction around the pair of coil shafts 155 having the upper ends affixed to the reflector holder 140, thereby generating a magnetic field of predetermined strength around the coil shafts 155.

Since each of the coil portions 150b includes the yoke 151 and the magnet 152 to produce the magnetic field of predetermined strength, and is received in one of the pair of magnetic portions 150a mounted at the bottom surface of the base 110, based on Fleming's left-hand rule, one of the coil portion 150b is externally forced to be raised, while the other coil portion 150b is externally forced to be lowered.

In this case, since the reflector holder 140 is integrally provided at the lower surface thereof with the fixed center body 132 of the torsion unit 130 that is integrally received in the opening 121 of the holder supporting unit 120, and the lateral wings 131 and 133, extending from the opposite lateral ends of the fixed center body 132 are integrally connected to the holder supporting unit 120 located on the fixed base 110 at a fixed position, the lateral wings 131 and 133, extending from the fixed center body 132, are forcibly distorted when external force is vertically applied to one side of the lower surface of the holder supporting unit 120.

Thereby, the reflector holder 140 is tilted relative to an imaginary horizontal axis, for example, in a clockwise direction by a predetermined inclination as one of the coil shafts 155 is raised and the other coil shaft 155 is lowered about the horizontal torsion unit 130 as a tilting center axis.

Simultaneously, the image reflector M, integrally provided on the reflector holder 140, is tilted in the clockwise direction. As a result, light, directed to the image reflector M via the digital mirror device, is reflected at a tilted reflective surface of the image reflector M. Thereby, the light is irradiated to the screen after being converted in a light path.

Therefore, if electric currents having different polarities are alternately applied to the coil portions 150b by a predetermined period under operation of the controller of the power source, the coil shafts 155 are alternately raised and lowered repeatedly at opposite sides of the torsion unit 130, allowing both the image reflector M and the reflector holder 140 to be tilted by a fast speed of 10 μs. In this way, the path of the light, directed to the image reflector M via the digital mirror device, is repeatedly converted vertically or horizontally relative to the image formation screen.

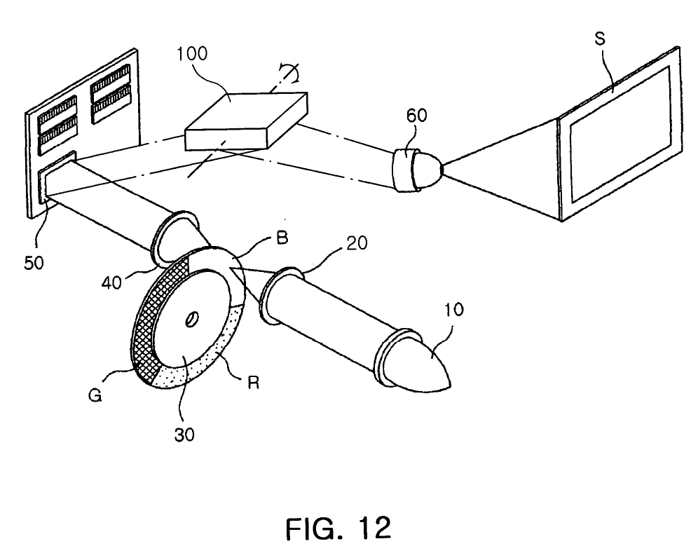

As shown in FIG. 12, white light, emitted from the light source 10, has a color corresponding to an image displayed on the digital mirror device 50 while passing through the color wheel 30. The image, displayed on the digital mirror device 50, is reflected to the image reflector M of the tilting actuator 100, and then, is reflected to the projection lens 60 to be enlarged via the projection lens 60, thereby being displayed on the screen S as a large scene.

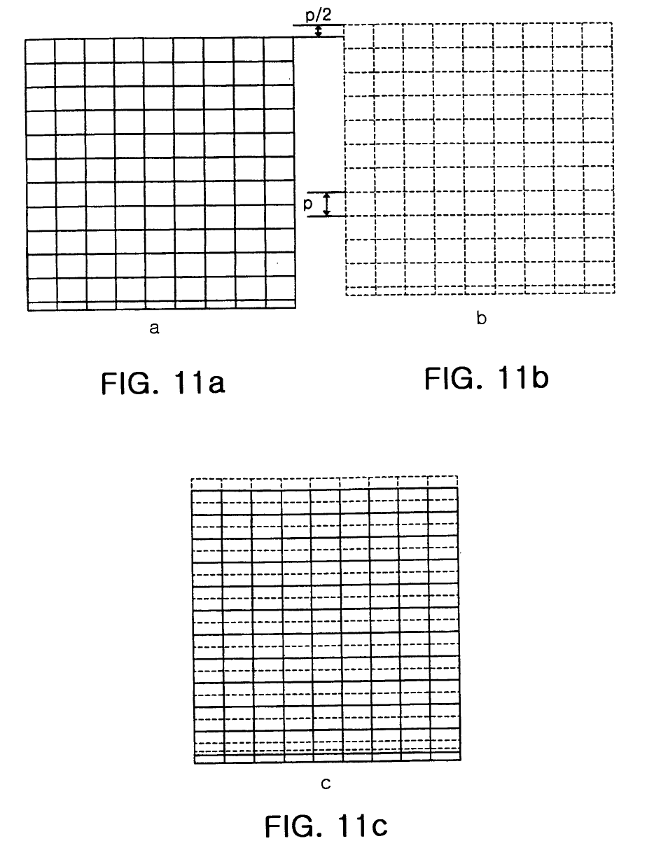

Referring to FIG. 11a, an image (a), projected on the screen S at an initial position of the tilting actuator 100, is shown by solid lines.

In the initial state of the tilting actuator 100, if the coil shafts 155, connected to the reflector holder 140, are repeatedly moved vertically as the magnetic portions 150a of the tilting drive unit 150 are driven using power supplied to the tilting actuator 100, the reflector holder 140 is tilted by a predetermined tilting angle to thereby cause the image reflector M to be tilted by a slight tilting angle. Thereby, the image displayed on the screen S is slightly moved. Referring to FIG. 11b, the slightly moved image (b) is shown by dotted lines.

In succession, if the images (a) and (b) are periodically repeatedly displayed on the screen S for a short interval of less than 0.02 sec. as the tilting drive unit 150 is periodically repeatedly operated, according to a visual ability of a human being, the images (a) and (b) are seen as an overlapped state, i.e. a combined image (c) as shown in FIG. 11c.

In this case, if a movement degree of the image obtained by the tilting actuator 100 is a half of a vertical height p of an original pixel, i.e. p/2, the images (a) and (b) are overlapped by half of a pixel. Since a viewer recognizes a pixel of the combined image (c) of FIG. 11c, that is reduced into a half size, as an original pixel due to an optical illusion phenomenon. This has the effect of improving the actual visible revolution of images.

In the present invention, meanwhile, even if the horizontal degree of the image reflector M provided on the reflector holder 140 does not coincide with a standard horizontal degree of the upper surface of the base 110, the horizontal degree of the image reflector M is able to be adjusted by means of the plurality of adjustment screws, which are provided between the base 110 and the reflector holder 140 and are fastened through the upper and lower screw holes of the base 110 and the holder supporting unit 120.

As is apparent from the above description, the present invention provides a tilting member and a tilting actuator having the same, in which a reflector holder, configured to mount an image reflector thereon, is connected to a holder supporting unit by interposing a torsion unit so as to be repeatedly tilted in opposite directions about the torsion unit as the torsion unit is distorted upon receiving upward external force, resulting in a more smooth tilting operation of the image reflector without generation of noise and vibration and achieving a reduction in manufacturing costs thereof.

Further, according to the present invention, when the image reflector is tilted to convert a path of light directed to a screen, a flatness of the image reflector can be accurately and simply adjusted, resulting in high image quality.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A tilting member comprising:
a holder supporting unit formed with at least one opening having a predetermined size;
a torsion unit connected at opposite lateral ends thereof to opposite inner sides of the opening; and
a reflector holder connected to the holder supporting unit via the torsion unit and adapted to perform a slight tilting movement about the torsion unit.

2. The tilting member as set forth in claim 1, wherein the torsion unit includes:
a fixed center body integrally provided at a lower surface of the reflector holder; and
a pair of lateral wings horizontally extending from opposite lateral ends of the fixed center body to be integrally connected to the opposite inner sides of the opening.

3. The tilting member as set forth in claim 2, wherein the fixed center body has a width lager than a width of the lateral wings.

4. The tilting member as set forth in claim 2, wherein the lateral wings have a thickness different from a plate thickness of the holder supporting unit.

5. The tilting member as set forth in claim 2, wherein the fixed center body has a thickness larger than a plate thickness of the holder supporting unit to define a gap having a predetermined size between the holder supporting unit and the reflector holder.

6. The tilting member as set forth in claim 2, wherein the holder supporting unit and the reflector holder are arranged at different planes from each other by interposing the torsion unit.

7. The tilting member as set forth in claim 6, wherein the gap between the holder supporting unit and the reflector holder is controlled depending on a thickness of the fixed center body of the torsion unit.

8. The tilting member as set forth in claim 1, wherein a pair of torsion units horizontally extends from opposite lateral surfaces of the reflector holder to be connected to the opening of the holder supporting unit.

9. The tilting member as set forth in claim 8, wherein the holder supporting unit, the torsion units, and the reflector holder are arranged at the same plane as one another.

10. The tilting member as set forth in claim 9, wherein a gap between the holder supporting unit and the reflector holder is controlled depending on a length of the torsion units.

11. The tilting member as set forth in claim 1, wherein an image reflector is mounted on an upper surface of the reflector holder.

12. A tilting member comprising:
a holder supporting unit:
torsion units connected to an upper or lower surface of the holder supporting unit; and
a reflector holder integrally provided at opposite lateral sides thereof with the torsion units, respectively, and adapted to perform a slight titling movement about the torsion units.

13. The tilting member as set forth in claim 12, wherein each of the torsion units includes:
an external fixed body affixed to the holder supporting unit; and
an external neck portion to integrally connect the external fixed body to one of the opposite lateral sides of the reflector holder.

14. The tilting member as set forth in claim 13, wherein the external fixed body has a fixing hole for use in the insertion of one of fixing pins formed at the holder supporting unit.

15. The tilting member as set forth in claim 14, wherein a pair of upper fastening holes are formed at opposite lateral sides of the fixing hole to correspond to lower fastening holes of the holder supporting unit.

16. The tilting member as set forth in claim 14, wherein the fixing hole is positioned to have approximately the same horizontal axis as the external neck portion.

17. The tilting member as set forth in claim 12, wherein each of the torsion units includes:
an internal fixed body received in a torsion unit exposure opening perforated through the reflector holder to be affixed to the holder supporting unit; and
an internal neck portion to integrally connect the internal fixed body to the reflector holder.

18. The tilting member as set forth in claim 17, wherein the internal fixed body has a fixing hole for use in the insertion of one of fixing pins formed at the holder supporting unit.

19. The tilting member as set forth in claim 18, wherein a pair of upper fastening holes is formed at opposite lateral sides of the fixing hole to correspond to lower fastening holes of the holder supporting unit.

20. The tilting member as set forth in claim 16, wherein the fixing hole is positioned to have approximately the same horizontal axis as the internal neck portion.

21. The tilting member as set forth in claim 17, wherein the torsion unit exposure opening has approximately the same shape as the internal fixed body.

22. The tilting member as set forth in claim 12, wherein the holder supporting unit has one or more openings having a predetermined size and formed at locations corresponding to the reflector holder.

23. The tilting member as set forth in claim 12, wherein an image reflector is mounted on an upper surface of the reflector holder.

24. A tilting actuator comprising:
a base having an inner space;
a tilting member provided inside the base to perform a slight tilting movement, an image reflector being mounted on an upper surface of the tilting member; and
a tilting drive unit to provide external force to a reflector holder of the tilting member, thereby slightly tilting the reflector holder about a horizontally disposed torsion unit of the tilting member.

25. The tilting actuator as set forth in claim 24, wherein the tilting member includes:
a holder supporting unit formed with at least one opening having a predetermined size;
the torsion unit connected at opposite lateral ends thereof to opposite inner sides of the opening; and
the reflector holder connected to the holder supporting unit via the torsion unit and adapted to perform a slight tilting movement about the torsion unit.

26. The tilting actuator as set forth in claim 25, wherein the torsion unit includes:
a fixed center body integrally provided at a lower surface of the reflector holder; and
a pair of lateral wings horizontally extending from opposite lateral ends of the fixed center body to be integrally connected to the opposite inner sides of the opening.

27. The tilting actuator as set forth in claim 26, wherein the fixed center body has a width lager than a width of the lateral wings.

28. The tilting actuator as set forth in claim 26, wherein the lateral wings have a thickness different from a plate thickness of the holder supporting unit.

29. The tilting actuator as set forth in claim 26, wherein the fixed center body has a thickness larger than a plate thickness of the holder supporting unit to define a gap having a predetermined size between the holder supporting unit and the reflector holder.

30. The tilting actuator as set forth in claim 26, wherein the holder supporting unit and the reflector holder are arranged at different planes from each other by interposing the torsion unit.

31. The tilting actuator as set forth in claim 30, wherein the gap between the holder supporting unit and the reflector holder is controlled depending on a thickness of the fixed center body of the torsion unit.

32. The tilting actuator as set forth in claim 25, wherein a pair of torsion units horizontally extends from opposite lateral surfaces of the reflector holder to be connected to the opening of the holder supporting unit.

33. The tilting actuator as set forth in claim 32, wherein the holder supporting unit, the torsion units, and the reflector holder are arranged at the same plane as one another.

34. The tilting actuator as set forth in claim 33, wherein a gap between the holder supporting unit and the reflector holder is controlled depending on a length of the torsion units.

35. The tilting actuator as set forth in claim 24, wherein the tilting member includes:
a holder supporting unit:
torsion units connected to an upper or lower surface of the holder supporting unit; and
a reflector holder integrally provided at opposite lateral sides thereof with the torsion units, respectively, and adapted to perform a slight titling movement about the torsion units.

36. The tilting actuator as set forth in claim 35, wherein each of the torsion units includes:
an external fixed body to be affixed to the holder supporting unit; and
an external neck portion to integrally connect the external fixed body to one of the opposite lateral sides of the reflector holder.

37. The tilting actuator as set forth in claim 36, wherein the external fixed body has a fixing hole for use in the insertion of one of fixing pins formed at the holder supporting unit.

38. The tilting actuator as set forth in claim 37, wherein a pair of upper fastening holes are formed at opposite lateral sides of the fixing hole to correspond to lower fastening holes of the holder supporting unit.

39. The tilting actuator as set forth in claim 37, wherein the fixing hole is positioned to have approximately the same horizontal axis as the external neck portion.

40. The tilting actuator as set forth in claim 35, wherein each of the torsion units includes:
an internal fixed body received in a torsion unit exposure opening perforated through the reflector holder to be affixed to the holder supporting unit; and
an internal neck portion to integrally connect the internal fixed body to the reflector holder.

41. The tilting actuator as set forth in claim 40, wherein the internal fixed body has a fixing hole for use in the insertion of one of fixing pins formed at the holder supporting unit.

42. The tilting actuator as set forth in claim 41, wherein a pair of upper fastening holes are formed at opposite lateral sides of the fixing hole to correspond to lower fastening holes of the holder supporting unit.

43. The tilting actuator as set forth in claim 41, wherein the fixing hole is positioned to have approximately the same horizontal axis as the internal neck portion.

44. The tilting actuator as set forth in claim 40, wherein the torsion unit exposure opening has approximately the same shape as the internal fixed body.

45. The tilting actuator as set forth in claim 35, wherein the holder supporting unit has one or more openings having a predetermined size and formed at locations corresponding to the reflector holder.

46. The tilting actuator as set forth in claim 45, wherein a protrusion is formed at a lower surface of the reflector holder to correspond to each opening of the holder supporting unit, and a coil is wound around the protrusion.

47. The tilting actuator as set forth in claim 24, wherein the tilting member is a molded article made of a metal material having an elastic restoration force.

48. The tilting actuator as set forth in claim 24, wherein the tilting member is a molded article made of a resin material having an elastic restoration force.

49. The tilting actuator as set forth in claim 24, wherein the tilting drive unit includes:
one or more magnetic portions fixedly mounted at a bottom surface of the base; and one or more coil portions fixedly mounted to the reflector holder.

50. The tilting actuator as set forth in claim 49, wherein each magnetic portion includes:
a yoke having an opened upper end and a closed lower end to define an inner space, the lower end being fixedly located in a seating recess formed at the bottom surface of the base; and
a magnet received in the inner space of the yoke and adapted to produce a magnetic field of predetermined strength.

51. The tilting actuator as set forth in claim 50, wherein an upper yoke is inserted to the top of the yoke to be seated on an upper surface of the magnet.

52. The tilting actuator as set forth in claim 49, wherein each coil portion includes:
a coil shaft having a predetermined length, the coil shaft being affixed at an upper end thereof to the reflector holder to thereby be inserted into a corresponding one of the magnetic portions; and
a coil wound around the coil shaft to have a predetermined number of turns, the coil being electrically connected to an external power source.
